(19) United States
(12) Patent Application Publication
(10) Pub. No.: US 2005/0044226 A1
(43) Pub. Date: Feb. 24, 2005

(54) Method and apparatus for validating and ranking resources for geographic mirroring

(75) Inventors: Michael James McDermott, Oronoco, MN (US); Amartey Scott Pearson, Austin, TX (US); Kiswanto Thayib, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/631,936

(22) Filed: Jul. 31, 2003

(51) Int. Cl. G06F 15/173

(52) U.S. Cl. 709/226; 711/170

(57) ABSTRACT

Method and apparatus for validating and ranking of resources that may be switched between a primary system and one or more backup systems at a single site. One embodiment provides a method for ensuring accessibility of one or more disk units by a system, comprising: configuring a disk pool for the system; validating availability of the one or more disk units for the disk pool; verifying that the disk units are at the same site as the system, and selecting one or more valid disk units for the disk pool. The method may further comprise ranking of each disk unit for the disk pool and selecting one or more valid disk units for the disk pool according to ranking.

### BACKGROUND OF THE INVENTION

1. Field of the Invention

The present invention generally relates to management of computer resources. More particularly, the present invention relates to configuration and accessibility of resources for resource pools that are physically disperse.

2. Description of Related Art

Modern computer systems that service enterprise operations, such as sales or manufacturing operations of a large company, cannot tolerate long periods of unavailability. Disaster recovery has traditionally focused on unscheduled downtime due to, for example, power outages, natural disasters, site disasters, system hardware or software errors, application malfunctions and deliberate acts of sabotage. Unscheduled downtime has usually resulted in unavailability of computer resources so that backup systems from a remote recovery site could be used to restore operations. The business interruption may be many hours or even days.

Modern electronic commerce requires continuous system availability and protection from scheduled downtimes. During scheduled downtimes or outages of a system (e.g., a server), the system is deliberately made unavailable to users (e.g., client). These scheduled downtimes introduce disruption into the operation of the system and are also difficult to accommodate. Examples of scheduled downtime/outages include installation of new operating system and application software releases, system hardware upgrades, additions, removals, and maintenance, system backups, site maintenance, and application of program temporary fixes (PTFs). A system that has “continuous availability” is defined as a system having no scheduled or unscheduled outages.

One method for improving and enhancing system availability utilizes a clustered system. A cluster is a collection of computer system nodes that are located at a single site or that are distributed across multiple sites and that all cooperate and interoperate to provide a single, unified computing capability. A clustered system provides failover and switchover capabilities for computing systems, such as database servers or application servers. If a system outage or a site loss occurs, the functions that are provided on a clustered primary server system can be switched over (or failed over) to one or more designated backup systems that contain a current copy (replica) of the resources. The failover can be automatic for unscheduled outages. In the case of a scheduled outage, a switchover may be automatically or manually initiated as part of a scheduled outage procedure.

A cluster resource group that is a subset of a cluster and that has a number of members typically defines one of those members as the primary member for that cluster resource group. The primary member is the primary point of access for the group and hosts the resources currently used by the group. Other members within the group that are properly configured to be able to assume functions of the primary member, i.e., nodes that have their resources properly configured to assume the functions of the primary member, are referred to as backup members. In one example, backup members host redundant resources. In another example, a backup member may have access to primary resources that are normally hosted by the primary member. If a primary member fails, a backup member assumes the role of the primary member. When a backup member assumes the primary member functions, it either takes over the resources of the previous primary member or changes its redundant resources to be primary resources.

In the event of a failover or a switchover, Cluster Resource Services (CRS), which may be part of the server operating system and running on all systems, provides a switchover from the primary system to the backup system. This switchover causes minimal impact to the end user or applications that are running on a server system. Data requests are automatically rerouted to the backup (i.e., new primary) system. Cluster Resource Services also provides the means to automatically re-introduce or rejoin systems to the cluster, and restore the operational capabilities of the rejoined systems.

Another method for further increasing and enhancing system availability involves geographically dispersing computing systems and computer resources, such as data storage units. In such a geographically disperse computer system, different geographic sites have one or more computer subsystems, or nodes, that are able to control or host computer resources that are also located at that site. Each of the multiple geographic locations that have computing system nodes and resources are referred to as a “site.” The multiple sites that contain portions of a geographically disperse computing system are generally interconnected with a data communications system that support data exchange among all of the sites and the computer nodes located at those sites. A particular computing node that is part of a physically disperse computer system generally has direct access to resources, such as data storage devices, printers, and other shared peripheral devices, that are collocated with that node. These systems generally maintain redundant resources, such as data storage units, that contain duplicates of a primary resource. Typically, these redundant resources can be quickly configured to become primary resources if required. Geographically disperse computing systems maintain redundant resources by communicating resource mirroring data from primary sites to the other sites. Maintaining redundant resources in a group avoids single point failures for the group's operation.

Data is able to be stored in disk pools connected to one or more server systems. A disk pool is a set of disk units, such as a tower of disk units and a redundant array of independent disks (RAID). A disk pool is switched from a primary system to a backup system by switching ownership of the hardware entity containing the disk units of the disk pool from the primary system to the backup system. However, the disk units in the disk pool must be physically located in correct hardware entities (e.g., a tower which the primary and backup systems can access), and must follow many configuration and hardware placement rules. A user must follow these configuration and hardware placement rules when selecting disk units for the disk pool and when selecting primary and backup systems for accessing the disk pool. Otherwise, the disk pool may not be available for the primary system and/or the backup system when a switchover is attempted or when a failover occurs. The user must also follow these rules when changing the hardware configuration. The user has the responsibility to understand and follow the configuration and hardware placement rules to correctly configure the disk units and the cluster system. However, due to the complexity of the configuration and hardware placement rules, the user may be forced into a trial and error situation, resulting in unavailable disk units when a switchover occurs.

Geographically distributed computing systems introduce an additional condition in assigning a resource, such as a disk pool, to a server system. Resources, such as disk pools, can generally be assigned to computer systems that are located at the same physical site. A computing system that is located at one site cannot generally host a disk pool, for example, that is located at another site. Conventional computer resource groups generally require all nodes and resources to be collocated so that all nodes in the computer resource group have access to all resources allocated to the computer resource group, thereby limiting the flexibility of computer resource groups.

Therefore, there is a need for a system and method for ensuring that a set of disks (i.e., a disk pool, also known as an ASP) are accessible to a system at the same site when configuring a disk pool. Furthermore, there is a need for ensuring that valid disk units are selected for configuration in a disk pool.

### SUMMARY OF THE INVENTION

Generally, embodiments of the invention provide systems and methods for use in computing system groups that maintained redundant resources at geographically disperse locations in order to, for example, increase availability of the entire computing system group. The resources, such as disk units in disk pools, that are maintained at each site, are able to be switched between a primary system and one or more backup systems at a site. Each separate geographic location is referred to as a “site.” The primary system, any backup system(s) and one or more resources that are located a given site are able to be configured in a cluster to provide improved availability at that site. A cluster is defined as a group of systems or nodes that located at a site or distributed among multiple sites, where the nodes work together as a single system. Each computer system in the cluster is called a cluster node. Each site within the computing system group is able to have one or more computing system or nodes and the operation of the exemplary embodiments allows a site to operate with only one node. Each site in the computer system group is able to be configured as a production site, which contains the primary resources that are used for current operations, or as a mirror site, which contains redundant resources that mirror the primary resources located at the production site. The exemplary embodiments of the present invention facilitate proper validation and ranking of resources at a site for use by a cluster or computer nodes at that site. A set of interfaces is provided for creating, adding, changing, and deleting nodes in a cluster at a site.

In one embodiment, a mechanism is provided for validating and ranking one or more disk units that are located within the same site for a specified disk pool. In another embodiment, a mechanism is provided for validating accessibility of disk units in a disk pool for a node before configuring the node as a primary node or as a backup node for accessing the disk pool. In yet another embodiment, a mechanism is provided for validating disk units in a switchable disk pool when clustering of multiple nodes at a site is started in preparation for activating a switchover between a primary system and a backup system that are located at that site.

Briefly, in accordance with the present invention, a system, method and signal bearing medium for managing resources within a system includes configuring at least one resource for use by a system. The system is associated with a site containing the resource. The method also includes validating availability of the at least one resource for a resource pool. The validating includes determining accessibility by the system and verification that the resource is located at the site. The method also includes selecting, based upon the validating (which may include ranking), at least one of the at least one resource for the resource pool. Only the systems at the same site are checked to ensure that they have access to the resources at that site, and systems do not require access to resources at other sites.

In another aspect of the present invention, a system has a primary system that is associated with a site and a resource pool that is connected to the primary system. The system further has a processor configured to validate availability of at least one resource for the resource pool and to select at least one valid resource for the resource pool. The availability is validated based at least in part on the at least one resource being located at the site.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter which is regarded as the invention is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a computing system group illustrating the overall system architecture of an exemplary embodiment of the present invention.

FIG. 2 is a block diagram depicting a group member of the group shown in FIG. 1, according to an exemplary embodiment of the present invention.

FIG. 3 is selecting one or more DASDs for an ASP processing flow diagram according to an exemplary embodiment of the present invention.

FIG. 4 is an exemplary design of software classes and responsibilities of each software class according to an exemplary embodiment of the present invention.

FIG. 5 is a validity inspector object oriented design for an exemplary validity inspector according to an exemplary embodiment of the present invention.

FIG. 6 is an exemplary non-configured DASD validating and ranking for a selected ASP processing flow diagram according to an exemplary embodiment of the present invention.

FIG. 7 is an exemplary set of software objects utilized for checking switchability of IASPs for clustering operations according to an embodiment of the present invention.

FIG. 8 is a node and resource configuration for site of FIG. 1 according to an exemplary embodiment of the present invention.

FIG. 9 is an initial configuration processing flow according to an exemplary embodiment of the present invention.

### DESCRIPTION OF THE PREFERRED EMBODIMENTS

### Computing System Group

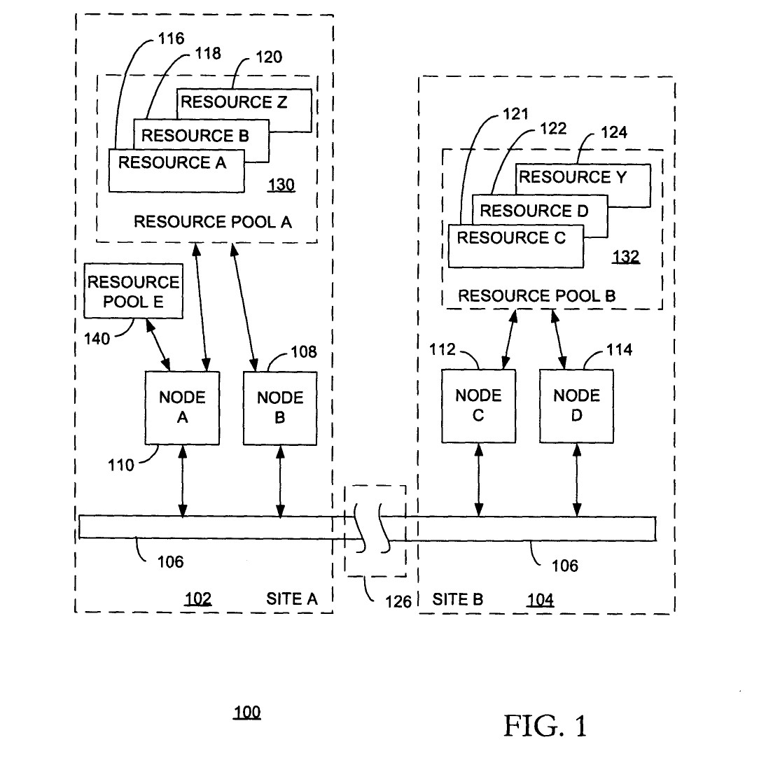

Referring now in more detail to the drawings in which like numerals refer to like parts throughout several views, a computing system group 100 illustrating the overall system architecture of an exemplary embodiment of the present invention is illustrated in FIG. 1. The exemplary computing system group 100 shows two sites, Site A 102 and Site B 104. Embodiments of the present invention operate with computing system groups that have any number of sites, from one to as many as are practical. The sites as used in this example are defined to be groups of computer nodes that have access to resources that are located within the physical location of the site. For example, the nodes within Site A 102, i.e., Node A 110 and Node B 108, have access to the resources within Resource Pool A 130, i.e., Resource A 116, Resource B 118 and Resource Z 120. Similarly, the nodes within Site B 104, i.e., Node C 112 and Node D 114, have access to the resources in Resource Pool B 132, i.e., Resource C 121, Resource D 122 and Resource Y 124. In addition to these resources that are accessible by multiple nodes at the associated site, Site A 102 includes Resource Pool E 140 that contains resources that are only accessible by node A 110 at that site. Resource Pool E 140 in this example is not accessible by Node B 108, or by the nodes located at site B 104. Resource pools that are accessible by multiple nodes at a site are able to be configured as switchable resource pools so that the node hosting the operation of that resource can be switched to other nodes at the same site.

Each site in the exemplary embodiment has a number of nodes. Site A 102 is shown to have a Node A 110 and a Node B 108. These nodes are connected via a data communications network 106 that supports data communications between nodes that are part of the same site and that are part of different sites.

In this example, the sites are geographically removed from each other and are interconnected by an inter-site communications system 126. The inter-site communications system 126 connects the normally higher speed data communications network 106 that is contained within each site. The inter-site communications system 126 of the exemplary embodiment utilizes a high-speed connection. Embodiments of the present invention utilize various inter-site communications systems 126 such as conventional WAN architectures, landline, terrestrial and satellite radio links and other communications techniques. Embodiments of the present invention also operate with any number of sites that have similar interconnections so as to form a continuous communications network between all nodes of the sites. Embodiments of the present invention also include “sites” that are physically close to each other, but that have computer nodes that do not have access to resources in the same resource pool. Physically close sites are able to share a single data communications network 106 and do not include a separate inter-site communications system 126.

Resources contained within resource pools, such as Resource Pool A 130 and Resource Pool B 132, include data storage devices, printers, and other peripherals that are controlled by one node within the group. In the computing system group 100, one node or member is designated as the primary member for the group. The primary group member hosts primary resources for the computing group and acts as the point of access and hosts the resources managed by the group.

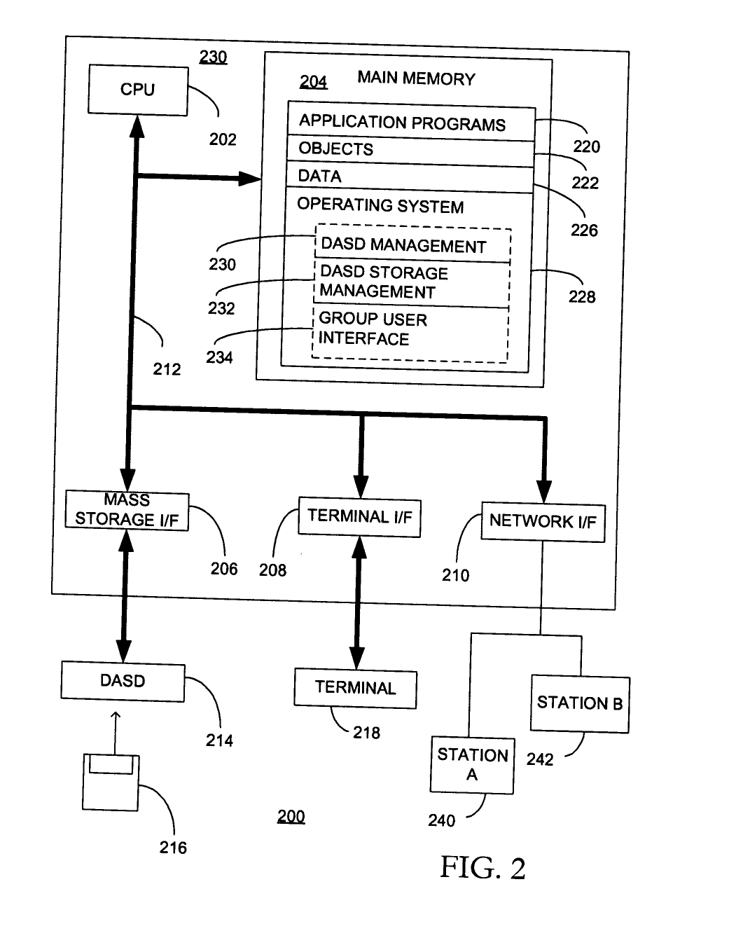

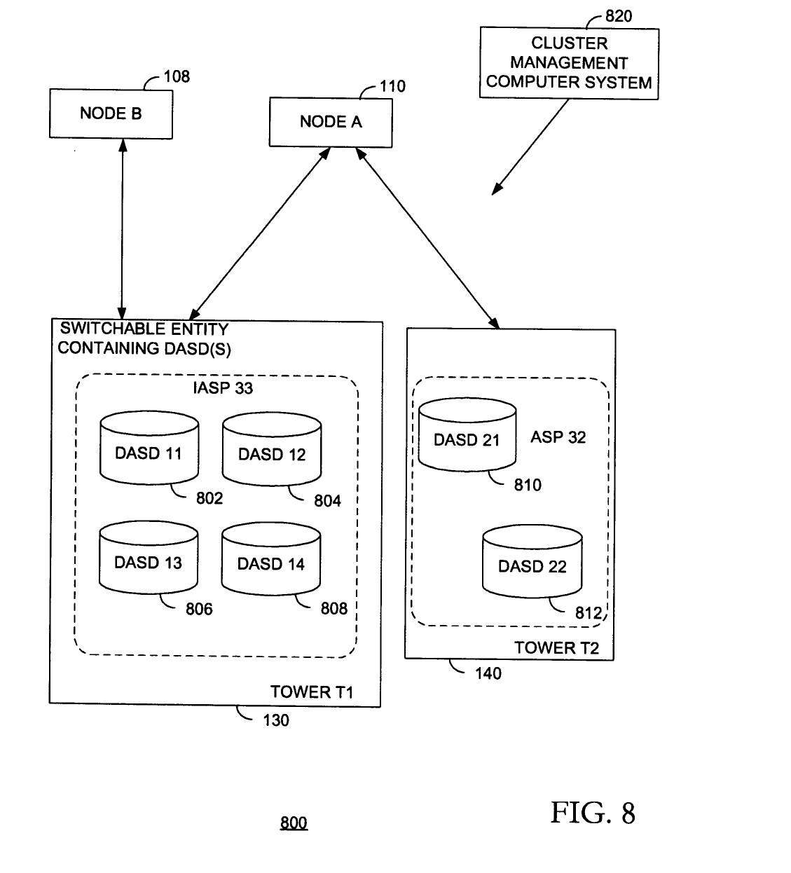

A node and resource configuration 800 for Site A 102 in an exemplary embodiment according to the present invention is illustrated in FIG. 8. The exemplary node and resource configuration 800 for Site A 102 includes Node A 110, Node B 108, Resource Pool A 130 that is a first tower of disk units, and Resource Pool E 140, that is a second tower of disk units. Cluster management operations may be performed utilizing operating systems in Node A 110 or Node B 108. Optionally, the node and resource configuration 800 may also include a cluster management computer system 820 which may be dedicated for performing operations related to configuration, changes, maintenance, and other tasks for the node and resource configuration 820. The cluster management computer system 820 may be connected to the other components of the node and resource configuration 800 through a network and may also comprise a computer system such as the computer system 200 described below in FIG. 2.

Resource Pool A 130 and Resource E 140 of this exemplary embodiment each include a plurality of disk units, such as a plurality of direct access storage disks (DASDs). Resource Pool A 130 of this exemplary embodiment includes DASD 11 802, DASD 12 804, DASD 13 806 and DASD 14 808, which may be proposed to be defined together as an independent auxiliary storage pool (IASP). Resource Pool E 140 includes DASD 21 810 and DASD 22 812, which may be proposed to be defined together as an auxiliary storage pool (ASP). Resource Pool A 130 is connected to, and therefore accessible by, both Node A 110 and Node B 108. Resource E is connected to, and therefore accessible by, only Node A 110. In this exemplary embodiment, Node A 110 is configured as the primary node for Resource Pool A 130, and Node B 108 is configured as the backup node for Resource Pool A 130 at Site A 102 (i.e., Node B 108 becomes the new primary node for Resource Pool A 130 when Node A 110 becomes unavailable because of a scheduled or unscheduled outage).

### Computer Nodes and Group Members

A block diagram depicting a group member 200, which is a computer system in the exemplary embodiment, of the group 100 according to an embodiment of the present invention is illustrated in FIG. 2. The group member 200 of the exemplary embodiment is an IBM eServer iSeries server system. Any suitably configured processing system is similarly able to be used by embodiments of the present invention. The computer system 200 has a processor 202 that is connected to a main memory 204, mass storage interface 206, terminal interface 208 and network interface 210. These system components are interconnected by a system bus 212. Mass storage interface 206 is used to connect mass storage devices, such as DASD device 214, to the computer system 200. One specific type of DASD device is a floppy disk drive, which may be used to store data to and read data from a floppy diskette 216.

Main Memory 204 contains application programs 220, objects 222, data 226 and an operating system image 228. Although illustrated as concurrently resident in main memory 204, it is clear that the applications programs 220, objects 222, data 226 and operating system 228 are not required to be completely resident in the main memory 204 at all times or even at the same time. Computer system 200 utilizes conventional virtual addressing mechanisms to allow programs to behave as if they have access to a large, single storage entity, referred to herein as a computer system memory, instead of access to multiple, smaller storage entities such as main memory 204 and DASD device 214. Note that the term “computer system memory” is used herein to generically refer to the entire virtual memory of computer system 200.

Operating system 228 is a suitable multitasking operating system such as the IBM OS/400 operating system. Embodiments of the present invention are able to use any other suitable operating system. Operating system 228 includes a DASD management user interface program 230, a DASD storage management program 232 and a group user interface program 234. Embodiments of the present invention utilize architectures, such as an object oriented framework mechanism, that allows instructions of the components of operating system 228 to be executed on any processor within computer 200.

Although only one CPU 202 is illustrated for computer 202, computer systems with multiple CPUs can be used equally effectively. Embodiments of the present invention incorporate interfaces that each include separate, fully programmed microprocessors that are used to off-load processing from the CPU 202. Terminal interface 208 is used to directly connect one or more terminals 218 to computer system 200. These terminals 218, which are able to be non-intelligent or fully programmable workstations, are used to allow system administrators and users to communicate with computer system 200.

Network interface 210 is used to connect other computer systems or cluster resource group members, e.g., Station A 240 and Station B 242, to computer system 200. The present invention works with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 216, CD ROM, or other form of recordable media, or via any type of electronic transmission mechanism.

Embodiments of the present invention include an operating system 228 that includes a DASD management user interface program 230 that performs functions related to configuration, operation and other management functions, including functions for selecting one or more DASDs for an auxiliary storage pool (ASP). An ASP is defined as a set of disk units, and an independent auxiliary storage pool (IASP) is a set of disk units independent of a system. An IASP can be switched between systems, if its disk units are switchable and follow configuration and placement rules. The DASD management user interface program 230 is able to communicate with DASD storage management (DSM) program 232, which is a component of operating system 228 that provides internal support for managing disk units.

### Processing Flows and Exemplary Software Design

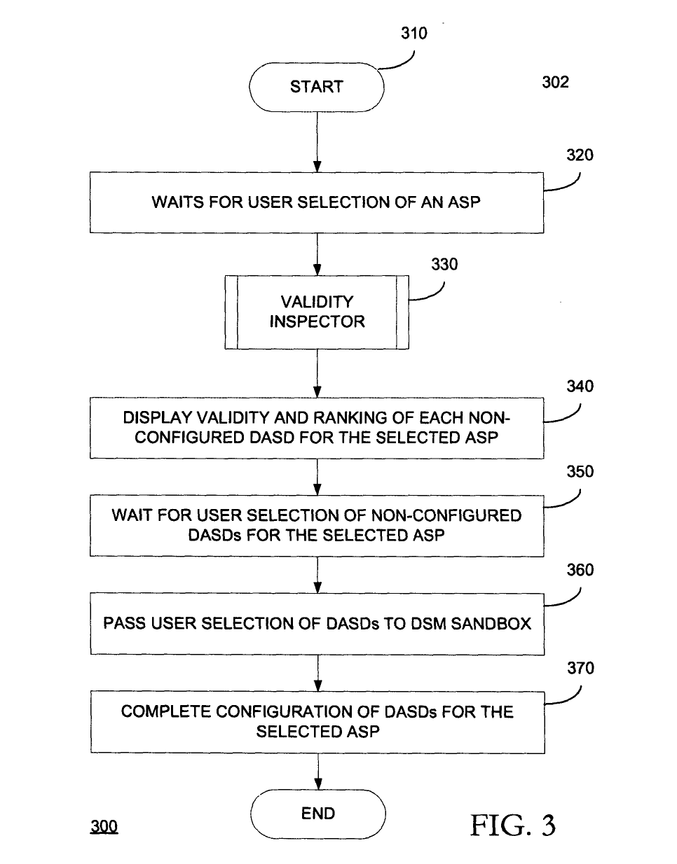

A selecting one or more DASDs for an ASP processing flow diagram 300 in accordance with an exemplary embodiment of the present invention is illustrated in FIG. 3. In the exemplary embodiment, the method 300 may be understood as illustrating a portion of the DASD Management user interface program 230 as related to selection of one or more DASDs for an ASP connected to a node that is located at a site. The method 300 begins at step 310 and waits at step 320 for user selection of an ASP for which one or more DASDs is to be configured. The user may select an existing ASP or a new ASP. In one embodiment, multiple DASDs and ASPs may be selected and processed in parallel. Once the user has entered the ASP selection, a validity inspector is invoked to provide validity and ranking results, at step 330, of all non-configured DASDs at the site of this node. Details of an exemplary validity inspector are described below. The results of the validity inspector, including the validity and ranking of each non-configured DASD for the selected ASP, are displayed to the user at step 340.

In one embodiment, the validity inspector checks the following rules to determine validity when selecting disk units for a disk pool. It is understood that the following rules are exemplary and that other sets of rules may be followed for other systems. A first rule is to determine and ensure that the selected DASDs are all associated with and located at the site containing the node performing the method 300. Another rule is that disk units in different disk pools that are separately switchable cannot be in the same switchable entity. For example, separately switchable disk pools cannot have disk units located in the same tower. Yet another rule is that disk units that are not going to be switched cannot be in a switchable hardware entity that contains disk units for disk pools that will be switched. For example, disk units that stay with a system (e.g., a system ASP, ASP 32 of Resource Pool E 140) cannot be in the same tower with disk units in a switchable disk pool (e.g., IASP 33 of Resource Pool A 130). A further rule specifies that disk units in a switchable disk pool to be switched between specific systems must be in hardware entities that those specific systems can access. For example, disk units intended to be switched to a backup system cannot be in a tower which the backup system cannot access. Yet another rule is that disk units in the same disk pool must be under hardware entities in the same power domain (i.e., powered on/off together). Other rules, such as rules regarding system constraints, may also be utilized to determine validity of the DASD selections.

In one embodiment, the valid DASDs at the site are displayed in ranked order. The output of the validity inspector may be one of the following: perfect, valid, warning, and invalid. The output “perfect” indicates that the selected DASD is the best DASD for the specified ASP. The output “valid” indicates that the DASD does not have the best ranking, but the DASD may be put in the ASP. The output “warning” indicates that the DASD may be invalid or questionable for the specified ASP. The output “Invalid” indicates that the DASD is not allowed to be put in the specified ASP. Details regarding the rankings of the selected DASD and the other non-configured DASDs may be obtained from a LdValidityForAsp object (i.e., LdValidityForAsp object 502 discussed below).

In one embodiment, the following factors are utilized for ranking the valid DASD selections. First, disk units for one disk pool are preferably kept under the same switchable hardware entity. Second, the primary and/or backup system preferably have direct access to the switchable hardware entity (i.e., without other entities in between). Third, disk units for one disk pool are preferably contained in one switchable hardware entity (i.e., the switchable hardware entity does not contain more than one IASP). It is understood that the above factors are exemplary and that other sets of factors may be utilized for other systems.

In another embodiment, the invalid DASDs may be displayed in addition to the valid DASDs. However, method 300 of the exemplary embodiment does not allow user selection of the invalid DASDs to be configured for the selected ASP. In another embodiment, each invalid DASD is displayed with one or more reasons for the invalid DASD being an inappropriate selection for the selected ASP. For example, besides switchability reasons, the invalid DASDs may be invalid because of capacity, protection, or other system rule violation. The user may change invalid DASDs to become valid DASDs (e.g., through physical movement of the DASD to an appropriate place) according to the invalidity reason.

At step 350, the method 300 waits for the user to select one or more valid non-configured DASDs in ranking order for the ASP. At step 360, the method 300 passes the DASD selections to a DSM sandbox, an object for holding parameters for DASD Storage Management program 234. Configuration of the selected valid DASDs for the ASP (or IASP) may be completed as known in the art at step 370, and the method 300 ends at step 380.

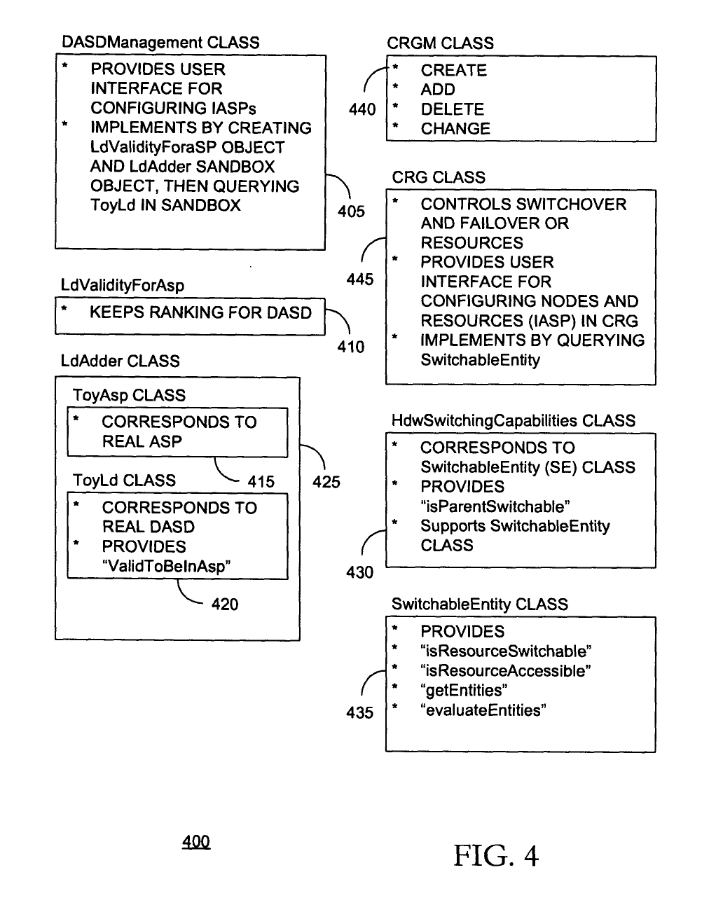

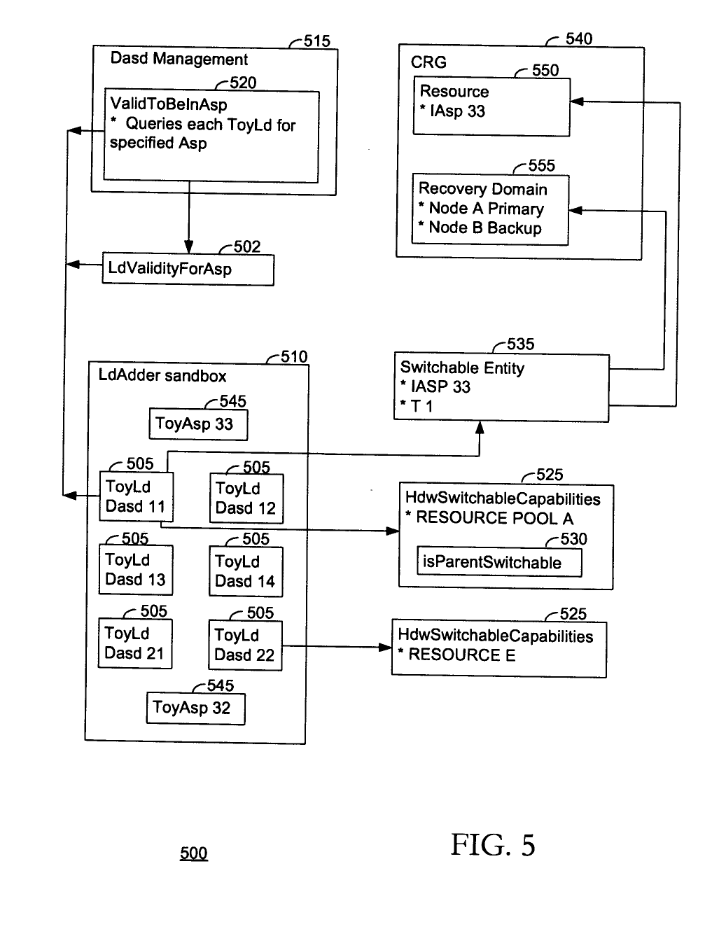

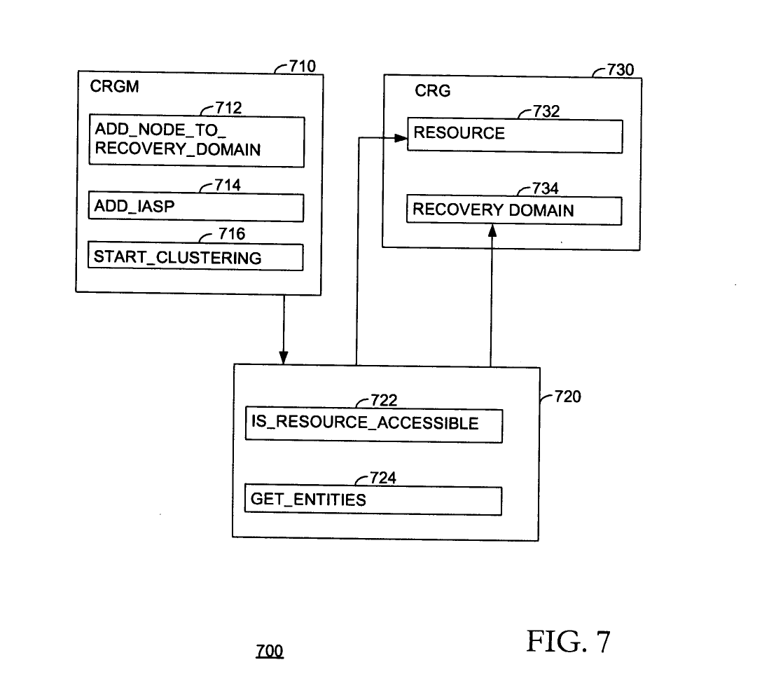

In one embodiment, the method 300 may be implemented utilizing object oriented programming. An exemplary design 400 of software classes and responsibilities of each software class according to an embodiment of the present invention is illustrated in FIG. 4. The related objects and methods of the classes are described in more detail below with reference to FIGS. 5 and 7. The software classes of the exemplary design 400 include a DASD Management (DM) class 405, a LdValidityForAsp class 410, a ToyAsp class 415, a ToyLd class 420, a HdwSwitchingCapabilities class 430, a SwitchableEntity class 435, a CRGM (Cluster Resource Group Management) class 440, and a CRG (Cluster Resource Group) class 445.

The DASD Management (DM) class 405 provides a user interface for configuring IASPs. In one embodiment, the DASD Management (DM) class 405 implements an IASP configuration by creating an LdValidityForAsp object and a LdAdder sandbox object and then querying each object (herein referred to as “ToyLd”) in the sandbox. The LdValidityForAsp (i.e., Logical DASD Validity For ASP) class 410 keeps the results of the validity and ranking for the non-configured DASDs in the LdValidityForAsp object.

The LdAdder (i.e., Logical DASD Adder) class 425 provides for selection of proposed DASDs and ASPs. Illustratively, the LdAdder class 425 comprises a ToyAsp (i.e., Toy ASP) class 415 representing the selected ASPs and a ToyLd (i.e., Toy Logical DASD) class 420 representing non-configured DASDs.

The HdwSwitchingCapabilities (i.e., Hardware Switching Capabilities) class 430 provides functions/methods for determining switchability of the tower where the DASDs are physically located. In one embodiment, the HdwSwitchingCapabilities class 430 provides an isParentSwitchable method and supports the SwitchableEntity class 435. The isParentSwitchable method determines whether the entity containing the disk unit is switchable.

The SwitchableEntity class 435 provides functions/methods for evaluating switchability, including an isResourceSwitchable function, an isResourceAccessible function and an evaluateEntities function. The isResourceSwitchable function determines whether the IASP is defined in a cluster resource group (CRG). The isResourceAccessible function determines whether nodes in a CRG recovery domain (i.e., primary and backup systems at the site containing the resource) can access the resource. The evaluateEntities function determines whether the entities are in the same CRG.

The CRGM (i.e., Cluster Resource Group Management) class 440 includes functions/support for creating, adding, changing, deleting and other operations relating to management of cluster resource groups. The CRG (i.e., Cluster Resource Group) class 445 controls switchover and failover of resources (e.g., IASPs) and provides user interface for configuring nodes and resources in CRG. In one embodiment, implementation of operations of the CRG class 445 includes queries utilizing functions provided in the SwitchableEntity class 435.

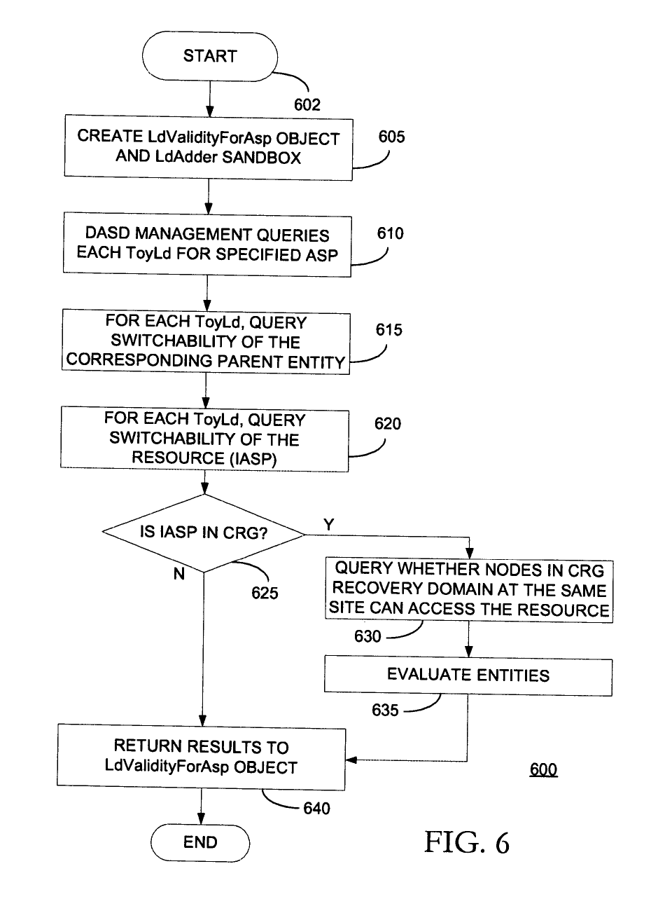

A validity inspector object oriented design 500 for an exemplary validity inspector 330 that operates on a node according to an embodiment of the present invention is illustrated in FIG. 5. An exemplary non-configured DASD validating and ranking for a selected ASP processing flow diagram 600 operating on a node according to an exemplary embodiment of the present invention is illustrated in FIG. 6. The processing flow 600 may be understood as an implementation of the validity inspector at step 330.

The method 600 begins at step 602 and proceeds to step 605 to create a LdValidityForAsp object 502 and a LdAdder sandbox 510. The LdValidityForAsp object 502 holds the switchability results including the validity and ranking of the non-configured DASDs that are located at the site containing this node. The LdAdder sandbox 510 holds proposed ASP objects 545 (e.g., ToyAsp 32 545 and ToyAsp 33 545 which, when configured, correspond to Resource E 140 and Resource Pool A 130 of the node and resource configuration 800, respectively) and the software equivalent objects of the hardware DASDs (e.g., ToyLd 505, one ToyLd for each DASD, including DASD 11 802, DASD 12 804, DASD 13 806, DASD 14 808, DASD 21 810 and DASD 22 812 as shown).

At step 610, the method 600 queries each ToyLd 505 (i.e., each non-configured DASDs) in the LdAdder sandbox 510 for its configuration into the specified ASP. The queries are invoked by DASD Management 515 via validToBeInAsp function 520 on each ToyLd object 505. At step 615, each ToyLd 505 then queries its corresponding HdwSwitchingCapabilities object 525 which provides the switching capabilities of the hardware entity (e.g., parent entity) physically containing the DASD corresponding to the ToyLd 505. The switching capabilities of the hardware entity are provided through a isParentSwitchable function 530.

Then at step 620, the method 600 queries the SwitchabilityEntity object 535 to determine whether the resource (i.e., the disk pool containing the DASD corresponding to the ToyLd being processed) is switchable. The SwitchableEntity object 535 queries the CRG object 540 to determine whether the resource (e.g., ToyAsp 33) is defined in a CRG. For example, for ToyLd DASD 11, the SwitchableEntity object 535 determines whether the resource ToyAsp 33 is defined in a CRG as a switchable IASP (e.g., Resource 550).

Next, at step 625, if the resource is switchable (i.e., if the resource is an IASP defined in a CRG), the method proceeds to perform additional queries at step 630 and 635. At step 630, the method 600 queries to determine whether nodes in the CRG recovery domain 555 (i.e., primary system and backup system located at the site containing the resource) can access the resource, and at step 635, the method 600 evaluates whether the entities (e.g., the resource and the node systems) are defined in the same CRG. Nodes that are located at different sites than a resource, for example, do not need to access that resource. Then at step 640, the switchability results of the non-configured DASDs are returned to the LdValidityForAsp object 502. Referring back to step 625, if the resource is not switchable, then the method 600 proceeds to step 640 and returns the switchability results of the non-configured DASDs to the LdValidityForAsp object 502. The method 600 then ends at step 650.

In another embodiment, the operating system 228 of the computer system 200 also includes a cluster user interface program 234 for clustering two or more computer systems in a cluster. The validity inspector may also be invoked to perform certain operations of the cluster user interface program 234. An exemplary set of software objects utilized for checking switchability of IASPs for clustering operations according to an embodiment of the present invention is illustrated in FIG. 7. Generally, in each of the following embodiments, the CRGM object 710 invokes one or more functions in the SwitchableEntity object 720, which validates the clustering operation through the CRG object 730.

In one embodiment, when adding a node to a CRG's recovery domain, the CRGM checks whether the proposed new node has access to the DASDs in the IASP(s). The CRGM add_node_to_recovery-domain function 712 invokes the isResourceAccessible function 722 and passes parameters including the proposed new node and the existing IASP(s). The isResourceAccessible function 722 checks the IASPs in the Resource object 732 and the nodes in the RecoveryDomain object 734 and determines whether the proposed new node has access to the DASDs in the IASP at the site to which the node belongs. If the proposed new node can access the DASDs in the IASP, the user is allowed to complete the CRGM operation. If the proposed new node does not have access to the DASDs in the IASP, a warning is displayed to the user configuring the proposed new node.

In another embodiment, when adding an IASP to the CRG, the CRGM checks whether all nodes in the specified recovery domain have access to the DASDs in the IASP to be added. The CRGM add_iasp function 714 invokes the isResourceAccessible function 722 and passes parameters including the proposed new IASP and the existing nodes in the specified recovery domain. The isResourceAccessible function 722 checks the IASPs in the Resource object 732 and the nodes in the RecoveryDomain object 734 and determines whether all nodes in the specified recovery domain at the site of the resource have access to the DASDs in the IASP to be added. If so, the user is allowed to complete the CRGM operation. If not, a warning is displayed to the user configuring the proposed new IASP.

When adding an IASP to the CRG, the CRGM may also check whether any other CRG has the same switchable entity (e.g., switchable tower) containing the IASP. The CRGM add_iasp function 714 invokes getEntities function 724 to retrieve the SwitchableEntity(s) for the proposed new IASP. The CRGM then searches other existing CRGs to determine whether any other CRG has the same switchable entity. If no other CRG has the same switchable entity, the user is allowed to complete the CRGM operation. If another CRG has the same switchable entity, a warning is displayed to the user adding the proposed IASP to the CRG.

In another embodiment, when starting the IASP's CRG (i.e., starting clustering), the CRGM validates the IASP's switchability. This additional validation serves to detect potential switchability errors due to hardware relocation (e.g., movement of cables and disk units). This additional validation may also detect errors due to improper DASD configuration (e.g., when the user configures a DASD when clustering was not active and the user ignores configuration warnings). The CRGM start_clustering function 716 invokes the isResourceAccessible function 722 and passes parameters including the existing IASP(s) in the Resource object 732. The isResourceAccessible function 722 checks the IASPs in the Resource object 732 and the nodes in the RecoveryDomain object 734 and determines whether all nodes at the same site in the recovery domain have access to the DASDs in the IASP. If so, the user is allowed to complete the CRGM start_clustering function. If not, a warning is displayed to the user attempting the clustering operation.

Embodiments of the present invention are incorporated within computer system groups 100 that are dispersed between or among multiple geographic locations. The nodes that make up the entire computer system group 100 are able to be distributed among the multiple geographic locations in any combination. Geographic locations, or sites, that have two or more nodes located therein are able to be configured within cluster resource groups and operate as part of recovery domains that include resources located at those sites, as is described herein. Alternatively, a site is able to have only one node that controls the resources at that site. This allows a reduction in cost by not requiring multiple nodes at each site while maintaining availability of the entire computing system group since a failure of the one node at that site is able to cause a failover to a node at another site. Another advantage of a site with a single computing system node is that the site does not require switchable hardware.

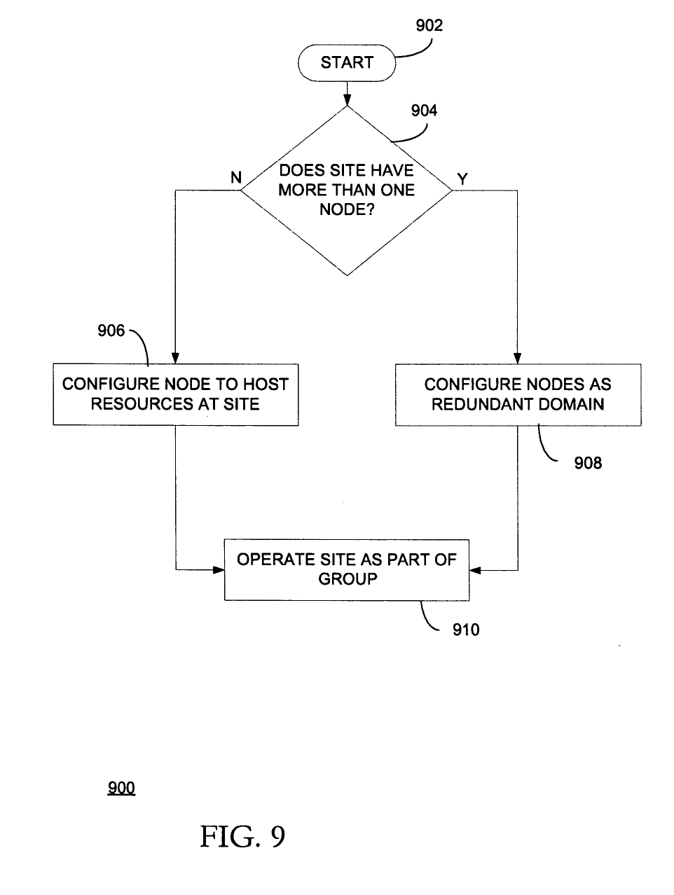

An exemplary initial configuration processing flow 900 according to an embodiment of the present invention is illustrated in FIG. 9. The exemplary initial configuration processing flow 900 accommodates site configurations that have only one node, while ensuring higher availability configurations of sites that have multiple nodes. The exemplary initial configuration processing flow 900 begins, at step 902, and proceeds to determining, at step 904, if the current site has more than one node. If this site does have more than one node, the processing continues by configuring, at step 908, the nodes at the site with a recovery domain for the resources located at this site. If this site has only one node, the processing continues by configuring, at step 906, that node to host the resources at this site. After configuring of the nodes at this site, the processing continues by operating, at step 910, the nodes at the site as members of the computing system group 100.

### Non-limiting Software and Hardware Examples

Embodiments of the invention can be implemented as a program product for use with a computer system such as, for example, the cluster computing environment shown in FIG. 1 and described herein. The program(s) of the program product defines functions of the embodiments (including the methods described herein) and can be contained on a variety of signal-bearing medium. Illustrative signal-bearing medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for managing resources within a node, the method comprising:
configuring at least one resource for use by a node, wherein the node is associated with a site containing the resource;
validating availability of the at least one resource for a resource pool, wherein the validating comprises determining accessibility by the node and verification that the resource is located at the site; and
selecting, based upon the validating, at least one of the at least one resource for the resource pool.

2. The method of claim 1, wherein the at least one resource comprises at least one disk unit, the method further comprising:
configuring the resource pool as a switchable disk pool.

3. The method of claim 1, wherein the node is a single node located at the site and the node operates as part of a geographically disperse computing system group.

4. The method of claim 1, wherein the at least one resource comprises at least one disk unit, the method further comprising,
ranking availability of each disk unit for the resource pool; and
selecting at least one valid disk unit for the resource pool according to availability ranking.

5. The method of claim 4, further comprising,
providing at least one reason to a user to explain validity and ranking of each disk unit.

6. The method of claim 1, wherein the node is part of a cluster resource group.

7. The method of claim 6, wherein the cluster resource group comprises a primary node and at least one backup node.

8. The method of claim 6, further comprising:
validating accessibility of resources in the resource pool when adding a node to a cluster resource group recovery domain, wherein the validating comprises determining that the node is associated with a site containing the resource pool.

9. The method of claim 6, further comprising:
when adding a switchable resource pool to the cluster resource group, verifying accessibility of each resource in the switchable resource pool by each node in the cluster resource group recovery domain located at the site.

10. The method of claim 9, further comprising:
verifying that a switchable entity containing the switchable resource pool is not included in another cluster resource group.

11. The method of claim 6, further comprising:
validating switchability of the switchable resource pool when starting clustering.

12. A signal bearing medium, comprising a program which, when executed by a processor, performs operations for managing resources within a node, the operations comprising:
configuring at least one resource for use by a node, wherein the node is associated with a site containing the resource;
validating availability of the at least one resource for a resource pool, wherein the validating comprises determining accessibility by the node and verification that the resource is located at the site; and
selecting, based upon the validating, at least one of the at least one resource for the resource pool.

13. The signal bearing medium of claim 12, wherein the steps further comprise configuring the resource pool as a switchable disk pool.

14. The signal bearing medium of claim 12, wherein the node is a single node located at the site and the node operates as part of a geographically disperse computing system group.

15. The signal bearing medium of claim 12, wherein the steps further comprise:
ranking of each resource for the resource pool; and
selecting at least one valid resources for the resource pool according to results of the ranking.

16. The signal bearing medium of claim 15, wherein the steps further comprise:
providing at least one reason to a user to explain validity and ranking of each resource.

17. The signal bearing medium of claim 12, wherein the node is part of a cluster resource group.

18. The signal bearing medium of claim 17, wherein the steps further comprise:
validating accessibility of resources in the resource pool when adding a node to the cluster resource group recovery domain.

19. The signal bearing medium of claim 17, wherein the steps further comprise verifying accessibility of each resource in the switchable resource pool by each node in the cluster resource group recovery domain when adding a switchable resource pool to the cluster resource group.

20. The signal bearing medium of claim 17, wherein the steps further comprise verifying that a switchable entity containing the switchable resource pool is not included in another cluster resource group.

21. The signal bearing medium of claim 17, wherein the steps further comprise validating switchability of the switchable resource pool when starting clustering.

22. A system, comprising:
a primary node that is associated with a site;
a resource pool connected to the primary node; and
a processor configured to validate availability of at least one resource for the resource pool and to select at least one valid resource for the resource pool, wherein the availability is validated based at least in part on the at least one resource being located at the site.

23. The system of claim 22, wherein the processor is further configured to rank each resource for the resource pool and select at least one valid resource for the resource pool according to ranking.

24. The system of claim 23, wherein the processor is further configured to provide at least one reason to a user to explain validity and ranking of each resource.

25. The system of claim 22, wherein the resource pool is configured as a switchable resource pool.

26. The system of claim 25, further comprising at least one backup node connected to the switchable resource pool.

27. The system of claim 25, wherein the processor is further configured to validate accessibility of resources in the switchable resource pool when adding a node to the cluster resource group recovery domain.

28. The system of claim 25, wherein the processor is further configured to, when adding the switchable resource pool to the cluster resource group, verify accessibility of each resource in the switchable resource pool by each node in the cluster resource group recovery domain.

29. The system of claim 25, wherein the processor is further configured to verify that a switchable entity containing the switchable resource pool is not included in another cluster resource group.

30. The system of claim 25, wherein the processor is further configured to validating switchability of the switchable resource pool when starting clustering.
